(19) United States
(12) Patent Application Publication
(10) Pub. No.: US 2005/0239492 A1
(43) Pub. Date: Oct. 27, 2005

(54) Reception device and mobile telephone terminal with such a reception device

(76) Inventors: Patrice Senn, Grenoble (FR); Faycal Touati, La Tronche (FR); Michel Pons, Meylan (FR)

Correspondence Address: MEYERTONS, HOOD, KIVLIN, KOWERT & GOETZEL, P.C., P.O. BOX 398, AUSTIN, TX, 78767-0398, US

(21) Appl. No.: 10/502,781

(22) PCT Filed: Jan. 24, 2003
(86) PCT No.: PCT/FR03/00240

§ 371 Date: Jun. 21, 2005

(30) Foreign Application Priority Data
Jan. 25, 2002 (FR) 02/00944

(51) Int. Cl. H04M 1/00

(52) U.S. Cl. 455/550.1; 455/575.1

(57) ABSTRACT

The reception device for a mobile telephone terminal includes an antenna coupled to a circuit for reception and processing of the radio waves received by the antenna. The antenna is embodied as a multi-sensor antenna to achieve a given level of spatial diversity whereby the sensors are coupled in parallel to the reception and processing circuit. The reception and processing circuit includes a number of reception and processing stages coupled in parallel to which are connected the sensors of the multi-sensor antenna.

### BACKGROUND OF THE INVENTION

1. Field of the Invention

The present invention relates to a reception device for mobile telephone terminal. It also relates to a mobile telephone terminal provided with such a reception device.

2. Description of the Relevant Art

There currently exist different types of reception devices for mobile telephone terminal. Such devices may be provided with antennas having a wire structure, in helix form, in plate form, etc. The operating principle of these antennas means that their dimensions are linked to the wavelength of the radio waves that they sense. Currently, the overall dimensions of such antennas are considerable.

Furthermore, one of the main concerns of the telecommunications operators is to optimize the link between the receiver and the transmitter, that is to say the base station with which the terminal is communicating, and to do so in order to allow good quality of service and a sufficiently high information bit rate, taking account of the technical constraints imposed upon them, relating in particular to the narrowness and the cost of the radiofrequency spectrum that can be used. Thus, optimizing the radio link means optimizing the information bit rate between the transmitter and the receiver and, in particular, minimizing the transmission error rate.

More specifically, for a mobile telephone terminal, the improvement of the reception bit rate is a major concern of the telecommunication operators. When an optimum information bit rate is obtained, another objective is to improve the link budget in order to optimize the reach of the terminal, or to minimize the electrical energy consumption of the terminals.

It is therefore desirable to provide a reception device for mobile telephone terminal allowing increased performance of the terminal antenna and to do so with relatively small overall dimensions.

### SUMMARY OF THE INVENTION

In one embodiment, a reception device is proposed for mobile telephone terminal including an antenna coupled to a circuit for reception and processing of the radio waves sensed by the antenna. According to one aspect of this device, the antenna includes a multi-sensor antenna suitable for obtaining a predetermined level of spatial diversity whereby the sensors are coupled in parallel to the reception and processing circuit. In addition, the reception and processing circuit includes a number of reception and processing stages coupled in parallel, to which the sensors of the multi-sensor antenna are coupled. Thus, by improving the spatial diversity of the reception device, that is to say by increasing the number of paths along which the radio waves are transmitted to the terminal, the signal to noise ratio is increased and the information bit rate toward the reception device is optimized. Furthermore, for an optimized information bit rate, the reach of the terminal and its battery life are improved.

According to one embodiment of this reception device, the number of reception and processing stages corresponds to the number of sensors of the antenna to which they are respectively connected.

According to another feature of this device, the multi-sensor antenna includes a number of broadband sensors whose bandwidth corresponds to the range of operating frequencies of the reception device, the reception and processing stages including single band circuits each suitable for the reception and processing of the radio waves sensed by the antenna across a range of frequencies corresponding to one operating mode of the receiver and each coupled to the whole set of sensors of the multi-sensor antenna.

According to another embodiment of this device, the multi-sensor antenna includes a number of broadband sensors, the reception and processing stages including broadband circuits, the bandwidth of the sensors and of the reception and processing stages corresponding to the range of operating frequencies of the reception device.

In preference, the device comprises means of adjusting the band of operating frequencies of each reception and processing stage.

According to another embodiment, the multi-sensor antenna includes several stages of single band sensors, the sensor stages each having a bandwidth corresponding to one operating range of the reception device. The sensors of each stage are jointly suitable for obtaining said level of spatial diversity.

The reception and processing stages each have a bandwidth corresponding to the operating range of the reception device, each sensor stage being coupled to all the reception and processing stages.

According to another feature of this device, advantageously, the multi-sensor antenna and the reception and processing circuit are integrated into an integrated circuit chip.

In an embodiment, a mobile telephone terminal, including a device for transmission and a device for reception of radio waves coupled to telephone circuits, according to which the reception device includes a reception device as defined above. The transmission and reception devices include distinct and separate telephone circuits.

### BRIEF DESCRIPTION OF THE DRAWINGS

Other aims, features and advantages of the invention will emerge from the following description, given only as nonlimiting examples, and made with reference to the appended drawings, in which:

FIG. 1 is a view in perspective of a telephone terminal;

FIG. 2 is a view in perspective of the motherboard of the telephone terminal in FIG. 1, showing the layout of the reception device with which the terminal in FIG. 1 is provided;

FIG. 3 is a block diagram illustrating a first embodiment of the reception device of the terminal in FIG. 1;

FIG. 4 illustrates schematically another embodiment of a device for receiving radio waves;

FIG. 5 illustrates a third embodiment of a reception device; and

FIG. 6 is a block diagram of a fourth embodiment of a reception device.

While the invention is susceptible to various modifications and alternative forms, specific embodiments thereof are shown by way of example in the drawings and will herein be described in detail. It should be understood, however, that the drawing and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE PREFERRED EMBODIMENTS

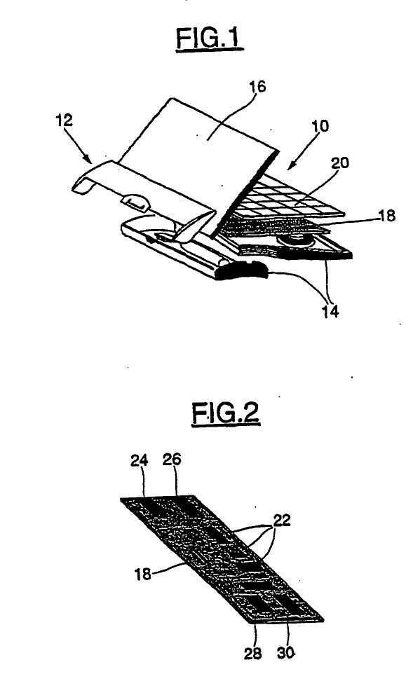

FIG. 1 shows a telecommunication terminal, indicated by the general reference number 10. In FIG. 1, the telecommunication terminal 10 is depicted as a personal digital assistant or “PDA.” It is understood, nevertheless, that the invention applies equally to any type of portable telecommunication terminal such as a cellular mobile telephone.

The terminal 10 includes a module 12 including a lower portion 14 and an upper portion 16 articulated one on the other and respectively incorporating, on the one hand, a mother board 18 and a keyboard 20 and, on the other hand, a screen (not shown).

As can be seen in FIG. 2, the motherboard 18 includes a number of electronic circuits mounted on an integrated circuit board including a central processing unit associated with mobile telephone circuits and memories, indicated generally by the reference number 22, and a radio wave reception device including an antenna with a number of sensors 24, 26, 28 and 30, dedicated to the reception of radio waves.

In addition, the motherboard 18 incorporates a radio wave transmission device including an antenna associated with mobile telephone circuits jointly transmitting radio signals toward a base station of a cell of a cellular telephone network with which the terminal 12 is communicating.

In the interests of clarity, the transmission device of the terminal 12, that is to say the transmitting antenna and the transmission circuits associated with it, have not been shown in FIG. 2. It will however be noted that the transmission device includes telephone circuits distinct and separate from the circuits of the reception device.

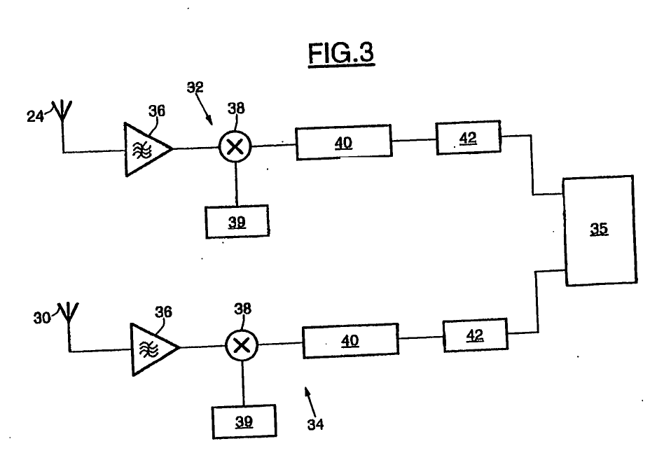

With reference to FIG. 3, the antenna of the reception device of the terminal 12, which receives the radio waves from the base station of the cell of the network in which the terminal lies, includes a multi-sensor antenna mounted on the motherboard 18.

The multi-sensor antenna used to produce the reception device includes a number of sensors 24, 26, 28 and 30, of conventional type, within the capability of those skilled in the art. They will therefore not be described in detail hereafter. It will however be noted that they are, in preference, made in the form of SMC components, that is to say surface mount components or in the form of integrated components mounted on a silicon chip, itself laid out on the motherboard 18. The sensors 24, 26, 28 and 30 of the antenna are positioned on the motherboard 18 in such a way as to obtain a level of spatial diversity by which to achieve a level of bit rate or of reach sufficient to achieve an acceptable link between the terminal and the base station with which the terminal 12 is communicating.

According to a first embodiment, visible in FIG. 3, the sensors 24, 26, 28 and 30 each include single band sensors, that is to say sensors having a narrow bandwidth centered on the operating frequency of the reception device or, in other terms, sensors chosen such that their bandwidth corresponds to the frequency of the standard of the mobile telecommunication system to which the terminal belongs. Each sensor 24, 26, 28 and 30 is coupled to a circuit 32, 34 for reception and processing of the radio waves received by the sensors organized in the form of a number of reception and processing stages coupled in parallel to a diversity processing processor 35 suitable for extracting from all the signals originating from the reception and processing circuit 32, 34 a single signal corresponding to the signal as it is sent by the base station.

Each reception and processing circuit 32, 34 also includes a single band circuit, its bandwidth corresponding substantially to the bandwidth of the sensor 24, . . . , 30, to which it is connected.

Since this is conventional, each reception and processing circuit 32, 34 comprises a low noise amplification (LNA) and filtering circuit 36 coupled, at the output, to a mixer circuit 38, which is associated with a local oscillator (VCO) 39 and which is itself coupled to a demodulation circuit 40 and to an analog/digital converter (ADC) 42. It will be noted nevertheless that the use of intermediate frequency amplifiers, each interposed between the mixer circuit and the demodulation circuit 40, could also be envisaged.

The processing of the radio waves received by each sensor 24, . . . , 30 is carried out in parallel manner, the signals being presented at the input of the processing processor only after analog/digital conversion. Thus all the difficulties encountered in a conventional manner in the field of microwave connection and the power losses caused in the event of antenna coupling are avoided.

In addition, to the extent that the antennas and the reception and processing circuits are integrated with the same motherboard, it is possible to couple the sensors extremely close to these circuits, which further helps to avoid the power losses at very high frequency. It is specifically possible, according to this arrangement, to couple the sensors and the reception and processing circuits in such a way that they are approximately 1 or 2 mm apart, or, generally, that they are separated by a distance corresponding to approximately two dimensions of an SMC component. Specifically, the coupling of the signals received from the base stations is performed only at the outputs of the reception and processing circuits 32, 34 and then relates only to digital circuits.

It is also possible, thanks to this arrangement, to optimize the impedance matching, that is to say to optimize it at a value leading to an optimum power transfer, to the extent that the constraints linked to particular connection necessities caused by a connection of antennas are dispensed with.

In the exemplary embodiment that has just been described, the antenna and the reception and processing circuits that are associated with it include single band elements whose bandwidth is centered on the operating frequency of the reception device. It will be noted nevertheless that such an arrangement may also be used for telecommunication terminals suitable for operating according to different standards, such as the GSM (“Global System for Mobile communications”) standard, the HiperLAN (“High performance radio LAN”) standard, the UMTS (“Universal Mobile Telecommunication System”) standard or the standard known as “Bluetooth”, while having an increased spatial diversity, that is to say according to operating modes according to each of which the reception device receives signals from a transmitter on a specific frequency.

Thus, for example, for an application according to which the terminal is suitable for operating in the aforementioned four modes, the reception device is produced in the form of four sets of four single band sensors each coupled to a corresponding reception and processing circuit, each set having an operating frequency corresponding to the frequency of the transmission mode in question. The reception device then has four operating modes while retaining a sufficient level of spatial diversity to achieve an optimum data transfer. It is nevertheless understood that such an arrangement is relatively complex and involves a relatively high-energy consumption.

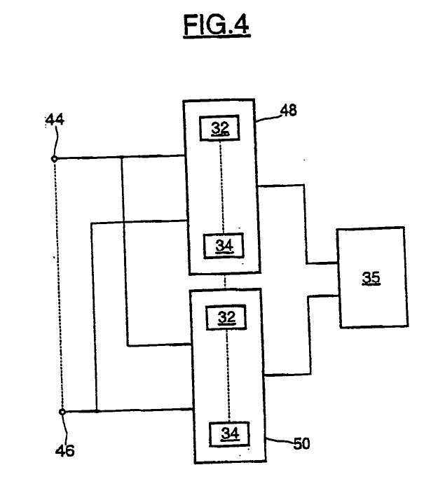

To alleviate this disadvantage, according to another embodiment, shown in FIG. 4, use is made of broadband sensors 44, . . . , 46 capable of covering the whole range of frequencies corresponding to the abovementioned four operating modes, for example the series of frequencies from 1.8 GHz to 5 GHz.

The sensors 44, . . . , 46 are then coupled to four sets of reception and processing circuits, such as 48 and 50, each dedicated to one of the operating modes in question and each including four single band reception and processing circuits identical to those described above with reference to FIG. 3, the sensors being coupled to the sets 48, 50 of reception and processing circuits by means of filters corresponding to the operating frequency of the latter.

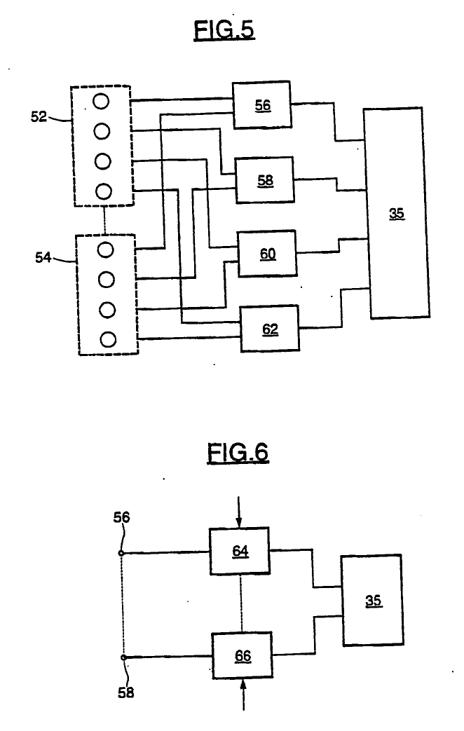

According to another embodiment, seen in FIG. 5, four sets of single band sensors are used, such as 52 and 54, each set having a frequency corresponding to one of the telecommunications modes, and four broadband or multiband reception and processing circuits 56, 58, 60 and 62, capable of covering the whole frequency range of the four operating modes envisaged. This limits the number of reception and processing circuits while retaining the required diversity effect, to the extent that four sensors are used for each operating mode in question.

Finally, according to a fourth embodiment, shown in FIG. 6, further simplifying the architecture of the reception device, four broadband or multiband sensors 56, . . . , 58 are used, that is to say having a range of operating frequencies covering the whole series of frequencies of the different modes envisaged. Likewise, broadband reception and processing circuits 60, . . . , 62 are used, to which the sensors 56, . . . , 58 are connected.

This then provides a set of sensors and corresponding reception and processing circuits that can operate according to the various modes and are also capable of conferring the required spatial diversity effect.

It will be noted that, according to a first variant, the modulation circuits forming part of the reception and processing circuits 64, . . . , 66 are suitable for achieving a parallel demodulation of the various signals received from the sensors and then include the same number of outputs as operating modes envisaged. This provides a reception device according to which all the envisaged operating modes may be implemented simultaneously, in parallel, while benefiting from the diversity effect.

According to another variant, demodulation circuits are provided each of which has only one output, that is to say that they are capable of demodulating signals according to only one mode at a time. Such an arrangement is used to reduce the complexity of the demodulator circuits forming part of the reception and processing circuits.

With such an arrangement, it is possible to use the capabilities of the broadband sensors and the corresponding reception and processing circuits to process, in parallel, and simultaneously, the signals received in the different modes. Nevertheless, the required diversity effect is not achieved.

If it is required to preserve this spatial diversity, the reception device is fitted with means of setting the bandwidth of the device, for example of the reception and processing circuits, in such a way as to set them all to the same frequency band, the signals originating from the various demodulators being recombined after analog or digital conversion. This gives an entirely reconfigurable receiver with reduced complexity.

Further modifications and alternative embodiments of various aspects of the invention may be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as the presently preferred embodiments. Elements and materials may be substituted for those illustrated and described herein, parts and processes may be reversed, and certain features of the invention may be utilized independently, all as would be apparent to one skilled in the art after having the benefit of this description to the invention. Changes may be made in the elements described herein without departing from the spirit and scope of the invention as described in the following claims. In addition, it is to be understood that features described herein independently may, in certain embodiments, be combined.

1. A reception device for mobile telephone terminal, comprising an antenna and a circuit for reception and processing of the radio waves sensed by the antenna, wherein the antenna is a multi-sensor antenna suitable for obtaining a predetermined level of spatial diversity, and wherein sensors are coupled in parallel to the reception and processing circuit, and wherein the reception and processing circuit comprises a number of reception and processing stages coupled in parallel, to which the sensors of the multi-sensor antenna are coupled, and wherein the multi-sensor antenna and the reception and processing circuit are integrated into an integrated circuit chip.

2. The reception device as claimed in claim 1, wherein the number of reception and processing stages corresponds to the number of sensors of the antenna to which they are respectively connected.

3. The reception device as claimed in claim 1, wherein the multi-sensor antenna comprises a number of broadband sensors whose bandwidth corresponds to the range of operating frequencies of the reception device and in that the reception and processing stages include single band circuits each suitable for the reception and processing of the radio waves sensed by the antenna across a range of frequencies corresponding to one mode of operation of the receiver and each coupled to the whole set of sensors of the multi-sensor antenna.

4. The reception device as claimed in claim 1, wherein the multi-sensor antenna comprises a number of broadband sensors and in that the reception and processing stages comprise broadband circuits, the bandwidth of the sensors and of the reception and processing stages corresponding to the range of operating frequencies of the reception device.

5. The reception device as claimed in claim 4, further comprising means of adjusting the operating frequency of each reception and processing stage.

6. The reception device as claimed in claim 1, wherein the multi-sensor antenna comprises a number of single band sensors, and in that the sensor stages each have a bandwidth corresponding to one operating range of the reception device, the sensors of each stage being jointly suitable for obtaining said level of spatial diversity.

7. The reception device as claimed in claim 6, wherein the reception and processing stages each have a bandwidth corresponding to the operating range of the reception device, each sensor stage being connected to all the reception and processing stages.

8. A mobile telephone terminal, comprising a transmission device and a radio wave reception device connected to telephone circuits wherein the reception device comprises an antenna and a circuit for reception and processing of the radio waves sensed by the antenna, wherein the antenna is a multi-sensor antenna suitable for obtaining a predetermined level of spatial diversity, and wherein sensors are coupled in parallel to the reception and processing circuit, and wherein the reception and processing circuit comprises a number of reception and processing stages coupled in parallel, to which the sensors of the multi-sensor antenna are coupled, and wherein the multi-sensor antenna and the reception and processing circuit are integrated into an integrated circuit chip.

9. The telephone terminal as claimed in claim 8, wherein the transmission device and the reception device are in distinct telephone circuits.

10. The telephone terminal as claimed in claim 8, wherein the number of reception and processing stages corresponds to the number of sensors of the antenna to which they are respectively connected.

11. The telephone terminal as claimed in claim 8, wherein the multi-sensor antenna comprises a number of broadband sensors whose bandwidth corresponds to the range of operating frequencies of the reception device and in that the reception and processing stages include single band circuits each suitable for the reception and processing of the radio waves sensed by the antenna across a range of frequencies corresponding to one mode of operation of the receiver and each coupled to the whole set of sensors of the multi-sensor antenna.

12. The telephone terminal as claimed in claim 8, wherein the multi-sensor antenna comprises a number of broadband sensors and in that the reception and processing stages comprise broadband circuits, the bandwidth of the sensors and of the reception and processing stages corresponding to the range of operating frequencies of the reception device.

13. The telephone terminal as claimed in claim 12, further comprising means of adjusting the operating frequency of each reception and processing stage.

14. The telephone terminal as claimed in claim 8, wherein the multi-sensor antenna comprises a number of single band sensors, and in that the sensor stages each have a bandwidth corresponding to one operating range of the reception device, the sensors of each stage being jointly suitable for obtaining said level of spatial diversity.

15. The telephone terminal as claimed in claim 14, wherein the reception and processing stages each have a bandwidth corresponding to the operating range of the reception device, each sensor stage being connected to all the reception and processing stages.
